(19) United States
(12) Patent Application Publication
(10) Pub. No.: US 2014/0285921 A1
(43) Pub. Date: Sep. 25, 2014

(54) SPINDLE MOTOR AND RECORDING DISK DRIVING DEVICE INCLUDING THE SAME

(71) Applicant: SAMSUNG ELECTRO-MECHANICS CO., LTD., Suwon (KR)

(72) Inventors: Sang Kyu LEE, Suwon (KR); Jin Seok Jang, Suwon (KR); Hong Joo Lee, Suwon (KR)

(73) Assignee: SAMSUNG ELECTRO-MECHANICS CO., LTD., Suwon (KR)

(21) Appl. No.: 13/948,729

(22) Filed: Jul. 23, 2013

(30) Foreign Application Priority Data
Mar. 25, 2013 (KR) 10-2013-0031481

(51) Int. Cl. H02K 1/27; H02K 1/17

(52) U.S. Cl. CPC H02K 1/2713; H02K 1/17; H02K 53/00
USPC 360/75; 310/156.11; 415/916; 74/DIG. 9

(57) ABSTRACT

There is provided a spindle motor including: a stator core fixedly installed on a stator; a driving magnet having a center thereof disposed to coincide with that of the stator core in an axial direction; and a rotor hub including a hub body having a disk shape, a magnet mounting part extended from an edge of the hub body in a downward axial direction and having the driving magnet installed on an inner peripheral surface thereof, and a disk supporting part extended from the magnet mounting part in a radial direction, wherein the stator includes a base member, and a pulling magnet is installed on at least one of a lower surface of the disk supporting part and an upper surface of the base member disposed to face the lower surface of the disk supporting part.

### CROSS-REFERENCE TO RELATED APPLICATIONS

This application claims the priority of Korean Patent Application No. 10-2013-0031481 filed on Mar. 25, 2013, in the Korean Intellectual Property Office, the disclosure of which is incorporated herein by reference.

### BACKGROUND OF THE INVENTION

1. Field of the Invention

The present invention relates to a spindle motor and a recoding disk driving device including the same.

2. Description of the Related Art

In a spindle motor for a hard disk drive (HDD), pulling force refers to force directed in a downward axial direction in order to prevent excessive floating of a rotor.

In addition, the spindle motor generally has a structure in which the pulling force is generated. Further, such pulling force serves to prevent the rotor from being separated from a stator when the spindle motor is driven in a state in which it is overturned, simultaneously with serving to suppress excessive floating of the rotor due to an external impact.

Here, a structure for generating pulling force will be briefly described. First, a structure for generating pulling force in which the centers (in other words, magnetic centers) of the driving magnet and the stator core are off-set from one another in an axial direction so as not to coincide with each other is provided.

That is, in this structure, in the case in which the center of the driving magnet in the axial direction is disposed in a position higher than that of the center of the stator core in the axial direction, the magnetic centers do not coincide with each other, such the pulling force acts toward a base member from a hub on which the driving magnet is installed.

Second, there is a structure for generating pulling force through interaction between the driving magnet and a pulling plate, formed of a ferromagnetic material, by installing the pulling plate in the base member so as to be disposed to face the driving magnet.

However, the two above-mentioned structures have the following problems.

First, in the structure for generating pulling force by disposing the centers of the driving magnet and the stator core so as not to coincide with each other in the axial direction, an axial length of the driving magnet may be unnecessarily increased, such that a cost required to manufacture the driving magnet may be increased.

Further, the magnetic centers are disposed so as not to coincide with each other, such that echo and high frequency noise are increased during driving the spindle motor, thereby increasing noise.

Further, in the structure for generating pulling force by disposing the pulling plate under the driving magnet, since magnetic force of the driving magnet should be used in order to generate pulling force, driving torque generated by the driving magnet is decreased. Therefore, a driving current is increased, and electromagnetic noise is generated due to a magnetic unbalance.

### RELATED ART DOCUMENT

### (Patent Document 1) Japanese Patent Laid-Open Publication No. 2005-45876

### SUMMARY OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

According to an aspect of the present invention, there is provided a spindle motor including: a stator core fixedly installed on a stator; a driving magnet having a center thereof disposed to coincide with that of the stator core in an axial direction; and a rotor hub including a hub body having a disk shape, a magnet mounting part extended from an edge of the hub body in a downward axial direction and having the driving magnet installed on an inner peripheral surface thereof, and a disk supporting part extended from the magnet mounting part in a radial direction, wherein the stator includes a base member, and a pulling magnet is installed on at least one of a lower surface of the disk supporting part and an upper surface of the base member disposed to face the lower surface of the disk supporting part.

The driving magnet and the pulling magnet may be formed of different materials.

The driving magnet and the pulling magnet may be disposed to be spaced apart from each other by a predetermined distance in the radial direction.

The pulling magnet may be formed of a rubber magnet containing Sr-Ferrite or Ba-Ferrite and having a residual magnetic flux density of 2 to 4 KGauss, and the driving magnet may be formed of a rare-earth magnet having a residual magnetic flux density of 6 to 15 KGauss.

The pulling magnet may be inserted into an installation groove recessed from the lower surface of the disk supporting part, and the stator may further include a pulling plate inserted into a mounting groove formed in the upper surface of the base member to generate pulling force in conjunction with the pulling magnet.

The base member may be formed of a diamagnetic or non-magnetic material.

The pulling magnet may be inserted into an installation groove recessed from the lower surface of the disk supporting part, and the base member may be formed of a ferromagnetic material so as to generate pulling force in conjunction with the pulling magnet.

The pulling magnet may be inserted into a mounting groove formed in the upper surface of the base member, and the rotor hub may be formed of a ferromagnetic material so as to generate pulling force in conjunction with the pulling magnet.

The pulling magnet may have a ring shape or a plurality of pulling magnets may be disposed to be spaced apart from each other in a circumferential direction.

The base member may include an installation part having the stator core installed on an outer peripheral surface thereof.

The stator may further include a sleeve supporting a shaft rotating together with the rotor hub.

The stator may further include a lower thrust member fixedly installed on the installation part and a shaft having a lower end portion fixed to the lower thrust member, and the rotor hub may be extended from a sleeve rotating around the shaft.

According to another aspect of the present invention, there is provided a recording disk driving device including: the spindle motor as described above rotating a recording disk; a head transfer part transferring a head detecting information of the recording disk mounted on the spindle motor to the recording disk; and a housing accommodating the spindle motor and the head transfer part therein.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to a first embodiment of the present invention;

FIG. 2 is an illustrative diagram showing a state in which a pulling magnet included in the spindle motor according to the first embodiment of the present invention is installed;

FIG. 3 is an illustrative diagram for describing a modified example of a pulling magnet included in the spindle motor according to the first embodiment of the present invention;

FIG. 4 is a schematic cross-sectional view showing a spindle motor according to a second embodiment of the present invention;

FIG. 5 is a schematic cross-sectional view showing a spindle motor according to a third embodiment of the present invention;

FIG. 6 is a schematic cross-sectional view showing a spindle motor according to a fourth embodiment of the present invention; and

FIG. 7 is a schematic cross-sectional view showing a recording disk driving device according to an embodiment of the present invention.

### DETAILED DESCRIPTION OF THE EMBODIMENTS

Embodiments of the present invention will now be described in detail with reference to the accompanying drawings. The embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the accompanying drawings of the present invention, shapes and dimensions of components may be exaggerated for clarity.

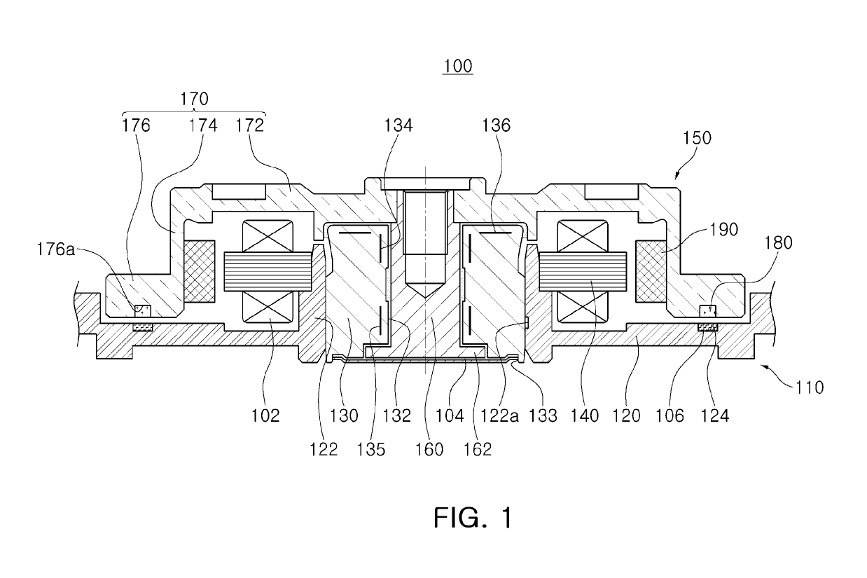

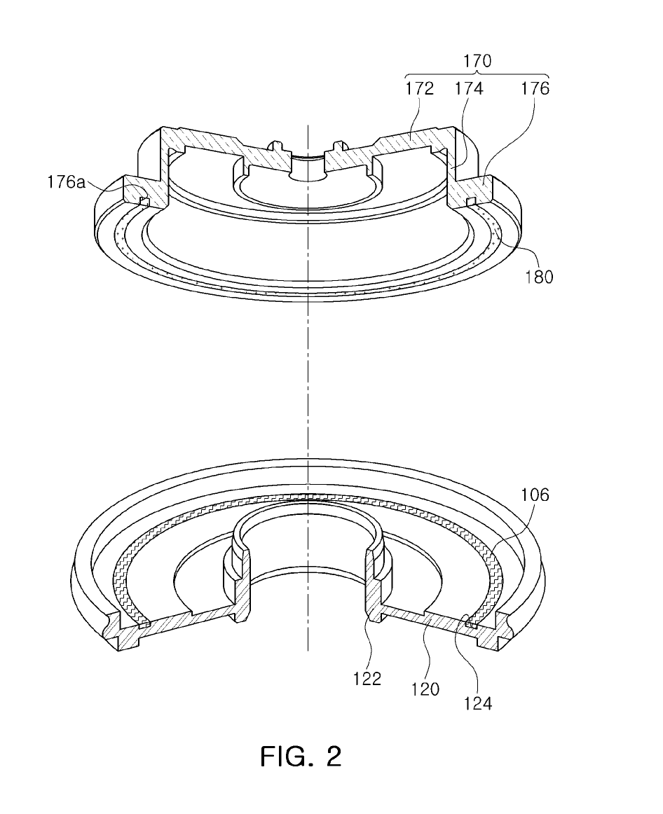

FIG. 1 is a schematic cross-sectional view showing a spindle motor according to a first embodiment of the present invention; and FIG. 2 is an illustrative diagram showing a state in which a pulling magnet included in the spindle motor according to the first embodiment of the present invention is installed.

Referring to FIGS. 1 and 2, the spindle motor 100 according to the first embodiment of the present invention may include a stator 110 and a rotor 150 by way of example.

Meanwhile, the spindle motor 100 according to the first embodiment of the present invention may be a motor used in a recording disk driving device rotating a recording disk.

In addition, the stator 110 indicates all fixed members rotatably supporting the rotor 150, and the rotor 150 indicates a rotating member supported by the stator 110 to thereby rotate.

Further, the stator 110 of the spindle motor 100 according to the first embodiment of the present invention may include a base member 120, a sleeve 130, and a stator core 140.

In addition, the rotor 150 of the spindle motor 100 according to the first embodiment of the present invention may include a shaft 160, a rotor hub 170, a pulling magnet 180, and a driving magnet 190.

Here, terms with respect to directions will be defined. As viewed in FIG. 1, an axial direction refers to a vertical direction, that is, a direction from a lower portion of the shaft 160 toward an upper portion thereof or a direction from the upper portion of the shaft 160 toward the lower portion thereof, and a radial direction refers to a horizontal direction, that is, a direction from an outer peripheral surface of the rotor hub 170 toward the shaft 160 or from the shaft 160 toward the outer peripheral surface of the rotor hub 170.

In addition, a circumferential direction refers to a rotation direction along an outer peripheral surface of the rotor hub 170 and the shaft 160.

The base member 120 may include an installation part 122 into which the sleeve 130 is inserted. The installation part 122 may protrude in an upward axial direction and include an installation hole 122a formed therein so that the sleeve 130 may be inserted thereinto.

In addition, the installation part 122 may include the stator core 140 installed on an outer peripheral surface thereof, wherein the stator core 104 has a coil 102 wound therearound. The stator core 140 may be fixedly installed on the outer peripheral surface of the installation part 122 by an adhesive or a press-fitting method.

Meanwhile, the base member 120 may have a mounting groove 124 formed in an upper surface thereof. The mounting groove 124 may have a pulling plate 106 formed therein in order to prevent, together with the pulling magnet 180, excessive floating of the rotor 150.

The sleeve 130 may be inserted into and fixed to the above-mentioned installation part 122. In other words, a lower end portion of an outer peripheral surface of the sleeve 130 may be bonded to an inner peripheral surface of the installation part 122 by at least one of an adhesion method, a welding method, and a press-fitting method.

Meanwhile, the sleeve 130 may include a shaft hole 132 formed therein, wherein the shaft hole 132 has the shaft 160 inserted thereinto. The shaft 160 may be inserted into the shaft hole 132 and be rotatably supported by the sleeve 130.

In addition, the sleeve 130 may include a mounting groove 133 formed at a lower end portion thereof, wherein the mounting groove 133 has a cover member 104 installed therein in order to prevent leakage of a lubricating fluid. Further, at the time of installing the cover member 104, a bearing clearance filled with the lubricating fluid may be formed by an upper surface of the cover member 104 and a lower surface of the shaft 160.

Next, the bearing clearance will be described.

The bearing clearance indicates a clearance filled with the lubricating fluid. That is, all of the clearance formed by an inner peripheral surface of the sleeve 130 and an outer peripheral surface of the shaft 160, the clearance formed by the sleeve 130 and the rotor hub 170, the clearance formed by the cover member 104 and the shaft 160, and the clearance formed by the shaft 160 and a lower surface of the sleeve 130 will be defined as the bearing clearances.

In addition, the spindle motor 100 according to the present embodiment may have a structure in which the lubricating fluid is filled in all of the above-mentioned bearing clearances, which is also called a full-fill structure.

In addition, the sleeve 130 may include upper and lower radial dynamic grooves 134 and 135 formed in the inner peripheral surface thereof in order to generate fluid dynamic pressure at the time of rotation of the shaft 160. In addition, the upper and lower radial dynamic grooves 134 and 135 may be disposed to be spaced apart from each other by a predetermined distance and have a herringbone or spiral shape.

However, the above-mentioned upper and low radial dynamic grooves 134 and 135 are not limited to being formed in the inner peripheral surface of the sleeve 130, but may also be formed in the outer peripheral surface of the shaft 160.

Further, an upper end portion of the outer peripheral surface of the sleeve 130 may be inclined so as to form a liquid-vapor interface F1 together with the rotor hub 170.

That is, the upper end portion of the outer peripheral surface of the sleeve 130 may be inclined in order to form the liquid-vapor interface F1 between the lubricating fluid and air by a capillary phenomenon.

Meanwhile, the sleeve 130 may have a thrust dynamic groove 136 formed in an upper surface thereof. In addition, the thrust dynamic groove 136 may also be formed in a lower surface of the rotor hub 170 disposed to face the upper surface of the sleeve 130. That is, the thrust dynamic groove 136 may be formed in at least one of the upper surface of the sleeve 130 and the lower surface of the rotor hub 170 disposed to face the upper surface of the sleeve 130.

However, the thrust dynamic groove 136 is not limited to being formed in at least one of the upper surface of the sleeve 130 and the lower surface of the rotor hub 170 disposed to face the upper surface of the sleeve 130, but may also be formed in at least one of the lower surface of the shaft 160 and the upper surface of the cover member 104 disposed to face the lower surface of the shaft 160.

The stator core 140 may be fixedly installed on the stator 110. That is, as described above, the stator core 140 may be fixedly installed on the outer peripheral surface of the installation part 122 of the base member 120.

Meanwhile, the stator core 140 may have the coil 102 wound therearound and serve to provide driving force capable of rotating the rotor 150 by an electromagnetic interaction with the driving magnet 190 in the case in which power is supplied.

The shaft 160 may be inserted into the sleeve 130 and rotate. That is, the shaft 160 may be rotatably supported by the sleeve 130. In addition, the shaft 160 may have a flange part 162 formed at a lower end portion thereof, wherein the flange part 162 is extended in an outer diameter direction and serve to prevent excessive floating of the shaft 160 simultaneously with preventing the shaft 160 from being separated upwardly from the sleeve 130.

That is, the flange part 162 may prevent the shaft 160 from being separated upwardly from the sleeve 130 due to external impact. In addition, the shaft 160 may be floated at a predetermined height at the time of being rotated. At this time, the flange part 162 may serve to prevent the shaft 160 from being excessively floated.

Further, the shaft 160 may have the rotor hub 170 coupled to an upper end portion thereof. To this end, in the case in which the shaft 160 is installed in the sleeve 130, the upper end portion of the shaft 160 may be disposed to protrude upwardly of the sleeve 130.

The rotor hub 170 may be fixedly installed on the upper end portion of the shaft 160 to thereby rotate together with the shaft 160. Meanwhile, the rotor hub 170 may include a hub body 172 having a disk shape, a magnet mounting part 174 extended from an edge of the hub body 172 in a downward axial direction and having a driving magnet 190 installed on an inner peripheral surface thereof, and a disk supporting part 176 extended from the magnet mounting part 174 in the radial direction.

Meanwhile, the driving magnet 190 installed on the inner peripheral surface of the magnet mounting part 174 may be disposed to face a front end of the stator core 140 having the coil 102 wound therearound. In this configuration, the center of the driving magnet 190 in the axial direction may be disposed to coincide with that of the stator core 140 in the axial direction.

In addition, the driving magnet 190 may have an annular ring shape and be a permanent magnet generating magnetic force having a predetermined strength by alternately magnetizing an N pole and an S pole in the circumferential direction.

Here, rotation of the rotor hub 170 will be briefly described. When power is supplied to the coil 102 wound around the stator core 140, driving force capable of rotating the rotor hub 170 may be generated by an electromagnetic interaction between the driving magnet 190 and the stator core 140 having the coil 102 wound therearound.

Therefore, the rotor hub 170 may rotate, and the shaft 160 to which the rotor hub 170 is fixedly installed may rotate together with the rotor hub 170 by the rotation of the rotor hub 170.

In addition, the disk supporting part 176 may have an installation groove 176a formed in a lower surface thereof, wherein the installation groove 176a has the pulling magnet 180 inserted thereinto.

The pulling magnet 180 may be inserted into the installation groove 176a formed in the lower surface of the disk supporting part 176 as described above. In addition, the pulling magnet 180 may be disposed to face the pulling plate 106 installed in the base member 120.

In other words, the pulling magnet 180 and the pulling plate 106 may be installed in the disk supporting part 176 and the base member 120, respectively, so as to face each other.

Therefore, force directed toward the base member 120 may be applied to the rotor hub 170.

Meanwhile, the pulling magnet 180 may be formed of a material different from that of the driving magnet 190. As an example, the pulling magnet 180 may be formed of a material generating magnetic force smaller than magnetic force generated by the driving magnet so as to decrease interference with the magnetic force generated by the driving magnet 190.

As an example, the pulling magnet 180 may be formed of a rubber magnet. In other words, the pulling magnet 180 may be manufactured by mixing acrylonitrile-butadiene (NBR) rubber with Ba-Ferrite powders or Sr-Ferrite powders. That is, the pulling magnet 180 may be a rubber magnet having a residual magnetic flux density of 2 to 4 KGauss and containing Sr-Ferrite or Ba-Ferrite.

In addition, the pulling magnet 190 may be formed of a rare-earth magnet. As an example, the driving magnet 190 may be an Nd—Fe—B based magnet having a residual magnetic flux density of 6 to 15 KGauss.

In addition, the pulling magnet 180 and the driving magnet 190 may have a shore scleroscope hardness of 30 to 50 Hs so as to facilitate assembly.

Further, the pulling magnet 180 may be disposed to be spaced apart from the driving magnet 190 by a predetermined distance in order to suppress magnetic force interference with the driving magnet 190.

As an example, the pulling magnet 180 may be disposed to be spaced apart from the driving magnet 190 in the axial direction and the radial direction.

Therefore, the pulling magnet 180 may provide pulling force directed toward the base member 120 to the rotor hub 170 while suppressing a decrease in driving force of the driving magnet 190.

Meanwhile, although the case in which the pulling magnet 180 is installed in the rotor hub 170 and the pulling plate 106 is installed in the base member 120 has been described by way of example in the present embodiment, the present invention is not limited thereto. That is, the pulling magnet 180 may be installed in the base member 120 and the pulling plate 106 may be installed in the rotor hub 170.

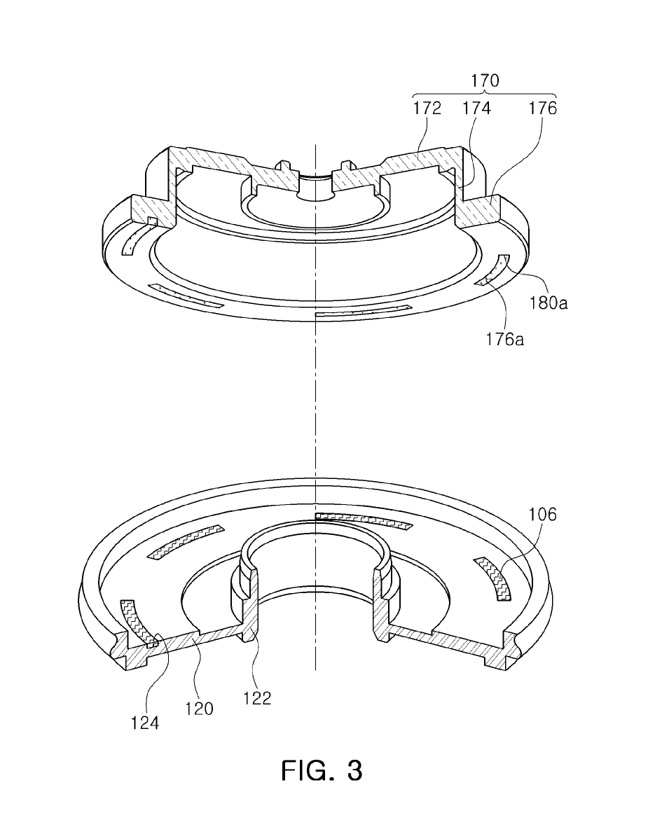

In addition, although the case in which the pulling magnet 180 is installed in the rotor hub 170 so as to have a ring shape as shown in FIG. 2 has been described by way of example in the present embodiment, the present invention is not limited thereto. That is, a plurality of pulling magnets 180a may be disposed to be spaced apart from each other in the circumferential direction as shown in FIG. 3.

As described above, the center of the stator core 140 in the axial direction and the center of the driving magnet 190 in the axial direction are disposed to coincide with each other to decrease an axial length of the driving magnet 190, whereby a cost required to manufacture the driving magnet 190 may be decreased.

Further, the magnetic centers of the stator core 140 and the driving magnet 190 are disposed to coincide with each other, whereby generation of echo noise and high frequency noise at the time of driving the spindle motor may be decreased.

Furthermore, pulling force is generated by the pulling magnet 180 and the pulling plate 106, such that the magnetic force of the driving magnet 190 may not be used, whereby a decrease in a driving torque may be prevented.

Therefore, a driving current may be decreased, and generation of electromagnetic noise may be decreased.

Next, spindle motors according to other embodiments of the present invention will be described with reference to the accompanying drawings. However, the same components as the above-mentioned components will be denoted by the same reference numerals, and a detailed description thereof will be omitted.

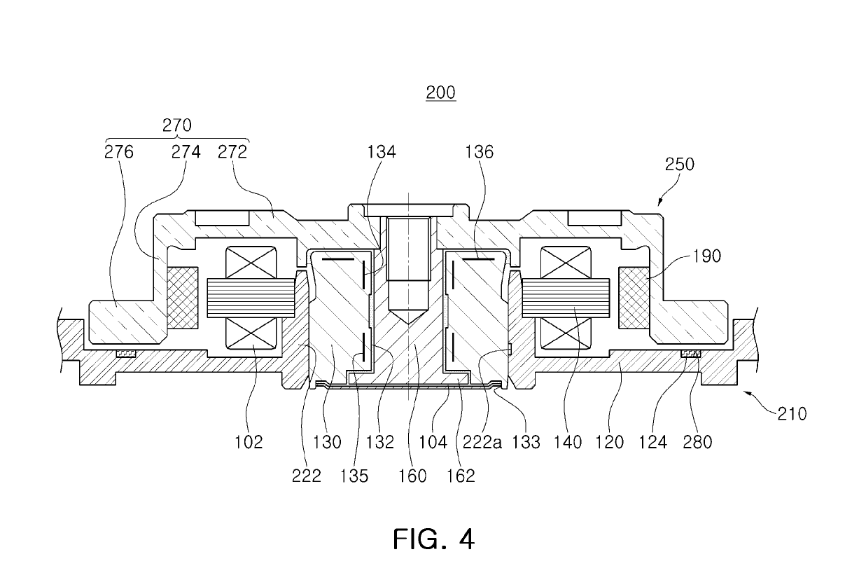

FIG. 4 is a schematic cross-sectional view showing a spindle motor according to a second embodiment of the present invention.

Referring to FIG. 4, the spindle motor 200 according to the second embodiment of the present invention may include a stator 210 and a rotor 250.

Meanwhile, the stator 210 of the spindle motor 200 according to the second embodiment of the present invention may include a base member 120, a sleeve 130, and a stator core 140.

In addition, the rotor 250 of the spindle motor 200 according to the second embodiment of the present invention may include a shaft 160, a rotor hub 270, a pulling magnet 280, and a driving magnet 190.

In addition, since components other than the rotor hub 170 and the pulling magnet 280 included in the spindle motor 200 according to the second embodiment of the present invention are substantially the same as components included in the spindle motor 100 according to the first embodiment of the present invention described above, a detailed description thereof will be omitted.

The pulling magnet 280 may be inserted into a mounting groove 124 formed in an upper surface of the base member 120. That is, the pulling magnet 280 may be installed in the base member 120 so as to face a lower surface of a disk supporting part 276 of the rotor hub 270.

Meanwhile, the rotor hub 270 may include a hub body 272 having a disk shape, a magnet mounting part 274 extended from an edge of the hub body 272 in the downward axial direction and having a driving magnet 190 installed on an inner peripheral surface thereof, and a disk supporting part 276 extended from the magnet mounting part 274 in the radial direction.

In addition, the rotor hub 270 may be formed of a ferromagnetic material.

Therefore, attractive force directed toward the base member 120 may be applied to the rotor hub 270 by magnetic force generated by the pulling magnet 280.

As described above, the force directed toward the base member 120 may be applied to the rotor hub 270 through the pulling magnet 280 installed in the base member 120 and the rotor hub 270 formed of the ferromagnetic material.

Further, the pulling magnet 280 may be formed of a material different from that of the driving magnet 190 described above. In addition, the pulling magnet 280 may be disposed to be spaced apart from the driving magnet 190 by a predetermined distance.

Meanwhile, the pulling magnet 280 may have a ring shape or a plurality of pulling magnets 280 may be disposed to be spaced apart from each other in the circumferential direction.

As described above, since the force directed toward the base member 120 may be applied to the rotor hub 270 through the rotor hub 270 formed of the ferromagnetic material and the pulling magnet 280, the center of the stator core 140 in the axial direction and the center of the driving magnet 190 in the axial direction may be disposed to coincide with each other.

Therefore, an axial length of the driving magnet 190 is decreased, whereby a cost required to manufacture the driving magnet 190 may be decreased and echo noise and high frequency noise generated at the time of driving the spindle motor may be decreased.

Further, the magnetic force of the driving magnet 190 may not be used, such that a decrease in a driving torque may be prevented.

In addition, a driving current may be decreased, and generation of electromagnetic noise may be decreased.

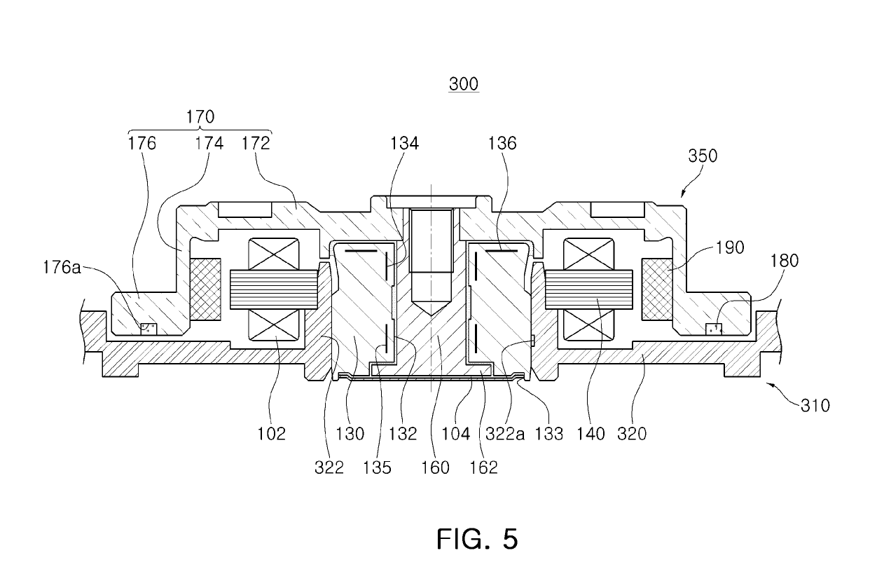

FIG. 5 is a schematic cross-sectional view showing a spindle motor according to a third embodiment of the present invention.

Referring to FIG. 5, the spindle motor 300 according to the third embodiment of the present invention may include a stator 310 and a rotor 350.

Meanwhile, the stator 310 of the spindle motor 300 according to the third embodiment of the present invention may include a base member 320, a sleeve 130, and a stator core 140.

In addition, the rotor 350 of the spindle motor 300 according to the third embodiment of the present invention may include a shaft 160, a rotor hub 170, a pulling magnet 180, and a driving magnet 190.

In addition, since components other than the base member 320 included in the spindle motor 300 according to the third embodiment of the present invention are substantially the same as components included in the spindle motor 100 according to the first embodiment of the present invention described above, a detailed description thereof will be omitted.

The base member 320 may include an installation part 322 into which the sleeve 130 is inserted. The installation part 322 may protrude in the upward axial direction and include an installation hole 322a formed therein so that the sleeve 130 may be inserted thereinto.

In addition, the installation part 322 may include the stator core 140 installed on an outer peripheral surface thereof, wherein the stator core 140 has a coil 102 wound therearound. The stator core 140 may be fixedly installed on the outer peripheral surface of the installation part 322 by an adhesive or a press-fitting method.

In addition, the base member 320 may be formed of a ferromagnetic material.

Meanwhile, the pulling magnet 180 may be installed in the disk supporting part 176 of the rotor hub 170 and have a ring shape or a plurality of pulling magnets 180 may be disposed to be spaced apart from each other in the circumferential direction.

As described above, since the force directed toward the base member 320 may be applied to the rotor hub 170 through the base member 320 formed of the ferromagnetic material and the pulling magnet 180, the center of the stator core 140 in the axial direction and the center of the driving magnet 190 in the axial direction may be disposed to coincide with each other.

Therefore, an axial length of the driving magnet 190 is decreased, whereby a cost required to manufacture the driving magnet 190 may be decreased and echo noise and high frequency noise generated at the time of driving the spindle motor may be decreased.

Further, the magnetic force of the driving magnet 190 may not be used, such that a decrease in a driving torque may be prevented.

In addition, a driving current may be decreased, and generation of electromagnetic noise may be decreased.

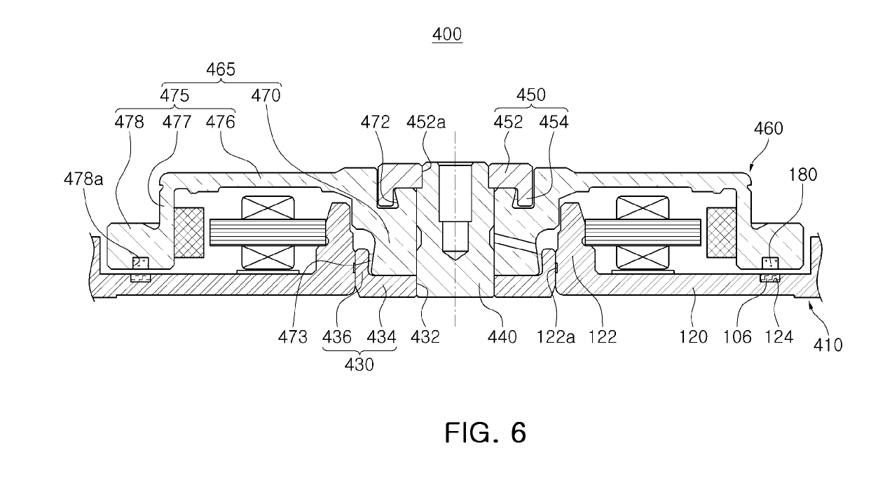

FIG. 6 is a schematic cross-sectional view showing a spindle motor according to a fourth embodiment of the present invention.

Referring to FIG. 6, the spindle motor 400 according to the fourth embodiment of the present invention may include a stator 410 and a rotor 460 by way of example.

Meanwhile, the stator 410 may include a base member 120, a lower thrust member 430, a shaft 440, an upper thrust member 450, and the like.

In addition, the rotor 460 may include a rotating body 465, a pulling magnet 180, and a driving magnet 190.

In addition, since the base member 120 of the stator 410 and the pulling magnet 180 and the driving magnet 190 of the rotor 460 are substantially the same as components included in the spindle motor 100 according to the first embodiment of the present invention, a detailed description thereof will be omitted.

The lower thrust member 430 may have a hollow cup shape. That is, the lower thrust member 430 may have an installation hole 432 formed therein so that a lower end portion of the shaft 440 may be inserted thereinto and fixed thereto.

In addition, the lower thrust member 430 may include a disk part 434 and an extension part 436 extended from an edge of the disk part 434 in the upward axial direction.

The shaft 440 may have the lower end portion fixedly installed on the lower thrust member 430. That is, the lower end portion of the shaft 440 may be inserted into the installation hole 432 formed in the disk part 434.

In addition, the shaft 440 may serve as the rotation axis of the rotor 460, and the rotor 460 may rotate around the shaft 440.

The upper thrust member 450 may be fixedly installed on an upper end portion of the shaft 440.

In addition, the upper thrust member 450 may also have a shape similar to that of the lower thrust member 430. That is, the upper thrust member 450 may include a circular ring part 452 and an extension wall part 454 extended from the ring part 452 in the downward axial direction.

In addition, the circular ring part 452 may also be provided with a through-hole 452a into which the upper end portion of the shaft 440 is inserted.

In addition, the rotating body 465 of the rotor 460 may include a sleeve 470 forming, together with the lower thrust member 430, the shaft 440, and the upper thrust member 450, bearing clearances, and a rotor hub 475 extended from the sleeve 470.

Meanwhile, although the case in which the sleeve 470 and the rotor hub 475 are formed integrally with each other has been described by way of example in the present embodiment, the present invention is not limited thereto. That is, the sleeve 470 and the rotor hub 475 may be manufactured as separate members and then coupled to each other.

The sleeve 470 may form, together with the lower thrust member 430, the shaft 440, and the upper thrust member 450, the bearing clearances as described above, wherein the bearing clearances may be filled with a lubricating fluid.

In addition, the spindle motor 100 according to the embodiment of the present invention may have a full-fill structure in which the lubricating fluid is filled in all of the above-mentioned bearing clearances.

Meanwhile, the sleeve 470 may have upper and lower inclined parts 472 and 473 formed on an outer peripheral surface thereof so as to form, together with the upper and lower thrust members 450 and 430, an interface between a lubricating fluid and air.

That is, the sleeve 470 may have the upper inclined part 472 formed at an upper end portion of the outer peripheral surface thereof so as to form, together with the upper thrust member 450, a liquid-vapor interface. Further, the lubricating fluid filled in the bearing clearance may form an interface with the air in a space formed by the extension wall part 454 of the upper thrust member 450 and the upper inclined part 472 by a capillary phenomenon.

In addition, the sleeve 470 may have the lower inclined part 473 formed at a lower end portion of the outer peripheral surface thereof so as to form, together with the lower thrust member 430, a liquid-vapor interface. Further, the lubricating fluid filled in the bearing clearance may form an interface with the air in a space formed by the extension part 436 of the lower thrust member 430 and the lower inclined part 473 by a capillary phenomenon.

Further, the sleeve 470 may include a radial dynamic groove (not shown) formed in an inner surface thereof in order to generate fluid dynamic pressure at the time of rotation. The radial dynamic groove may have a herringbone or spiral shape and include upper and lower radial dynamic grooves.

Further, a thrust dynamic groove (not shown) may be formed in at least one of a lower surface of the sleeve 470 and a facing surface of the lower thrust member 430 disposed to face the lower surface of the sleeve 470 and/or at least one of an upper surface of the sleeve 470 and a facing surface of the upper thrust member 450 disposed to face the upper surface of the sleeve 470. The thrust dynamic groove may also have a herringbone or spiral shape.

The rotor hub 475 may be extended from the sleeve 470. In addition, the rotor hub 470 may include a hub body 476 having a disk shape, a magnet mounting part 477 extended from an edge of the hub body 472 in the downward axial direction and having a driving magnet 190 installed on an inner peripheral surface thereof, and a disk supporting part 478 extended from the magnet mounting part 477 in the radial direction.

Meanwhile, the driving magnet 190 installed on the inner peripheral surface of the magnet mounting part 477 may be disposed to face a front end of the stator core 140 having the coil 102 wound therearound. In this configuration, the center of the driving magnet 190 in the axial direction may be disposed to coincide with that of the stator core 140 in the axial direction.

In addition, the driving magnet 190 may have an annular ring shape and be a permanent magnet generating magnetic force having a predetermined strength by alternately magnetizing an N pole and an S pole in the circumferential direction.

Here, rotation of the rotating body 465 will be briefly described. When power is supplied to the coil 102 wound around the stator core 140, driving force capable of rotating the rotating body 465 may be generated by an electromagnetic interaction between the driving magnet 190 and the stator core 140 having the coil 102 wound therearound. Therefore, the rotating body 465 may rotate.

In addition, the disk supporting part 478 may have an installation groove 478a formed in a lower surface thereof, wherein the installation groove 478a has the pulling magnet 180 inserted thereinto.

The pulling magnet 180 may be inserted into the installation groove 478a formed in the lower surface of the disk supporting part 478 as described above. In addition, the pulling magnet 180 may be disposed to face the pulling plate 106 installed in the base member 120.

In other words, the pulling magnet 180 and the pulling plate 106 may be installed in the disk supporting part 478 and the base member 120, respectively, so as to face each other.

Therefore, force directed toward the base member 120 may be applied to the rotating body 465.

Meanwhile, the pulling magnet 180 may be formed of a material different from that of the driving magnet 190. As an example, the pulling magnet 180 may be formed of a material generating magnetic force smaller than magnetic force generated by the driving magnet so as to decrease interference with the magnetic force generated by the driving magnet 190.

Further, the pulling magnet 180 may be disposed to be spaced apart from the driving magnet 190 by a predetermined distance in order to suppress magnetic force interference with the driving magnet 190.

As an example, the pulling magnet 180 may be disposed to be spaced apart from the driving magnet 190 in the axial direction and the radial direction.

Therefore, the pulling magnet 180 may provide pulling force directed toward the base member 120 to the rotor hub 475 while suppressing a decrease in driving force of the driving magnet 190.

Meanwhile, although the case in which the pulling magnet 180 is installed in the rotor hub 475 and the pulling plate 106 is installed in the base member 120 has been described by way of example in the present embodiment, the present invention is not limited thereto. That is, the pulling magnet 180 may be installed in the base member 120 and the pulling plate 106 may be installed in the rotor hub 475.

As described above, the center of the stator core 140 in the axial direction and the center of the driving magnet 190 in the axial direction are disposed to coincide with each other to decrease an axial length of the driving magnet 190, whereby a cost required to manufacture the driving magnet 190 may be decreased.

Further, the magnetic centers of the stator core 140 and the driving magnet 190 are disposed to coincide with each other, whereby generation of echo noise and high frequency noise at the time of driving the spindle motor may be decreased.

Furthermore, pulling force is generated by the pulling magnet 180 and the pulling plate 106, such that the magnetic force of the driving magnet 190 may not be used, whereby a decrease in a driving torque may be prevented.

Therefore, a driving current may be decreased, and generation of electromagnetic noise may be decreased.

Meanwhile, the case in which the spindle motor includes the pulling magnet 180 and the pulling plate 106 as in the spindle motor 100 according to the first embodiment of the present invention and has a fixed shaft structure in which the shaft 440 is fixedly installed has been described by way of example in the present embodiment.

However, the present invention is not limited thereto. That is, modified examples such as the second and third embodiments of the present invention may also be adopted in the fixed shaft structure.

Hereinafter, a recording disk driving device in which the spindle motor according to the embodiment of the present invention is mounted will be described.

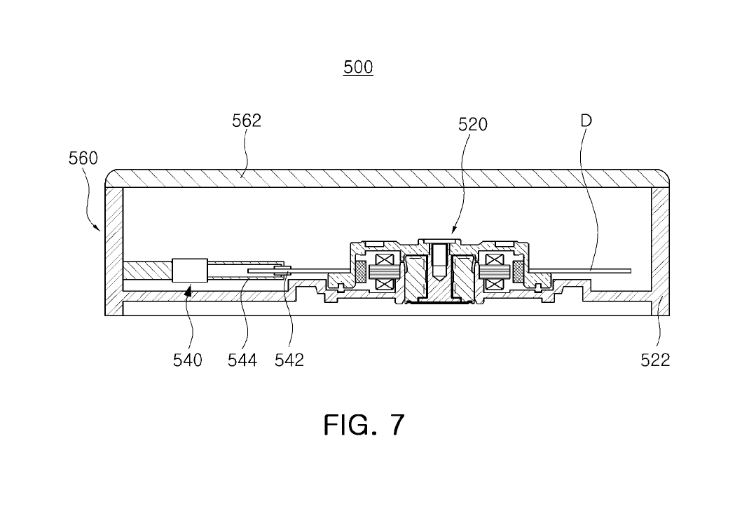

FIG. 7 is a schematic cross-sectional view showing a recording disk driving device according to the embodiment of the present invention.

Referring to FIG. 7, the recording disk driving device 500 according to the embodiment of the present invention may be a hard disk drive and include a spindle motor 520, a head transfer part 520, and a housing 560.

The spindle motor 520 may be any one of the spindle motors 100, 200, 300, and 400 according to the first to fourth embodiments of the present invention described above and have a recording disk D mounted thereon.

The head transfer part 540 may transfer a head 542 detecting information of the recording disk D mounted on the spindle motor 520 to a surface of the recording disk D of which the information is to be detected. The head 542 may be disposed on a support part 544 of the head transfer part 540.

The housing 560 may include a base member 522 and a top cover 562 covering an upper portion of the base member 522 in order to form an internal space accommodating the motor 520 and the head transfer part 540 therein.

As set forth above, according to the embodiment of the present invention, the pulling magnet is installed on at least one of the disk supporting part and the base member, whereby excessive floating of the rotor may be prevented and a driving torque may be increased.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a stator core fixedly installed on a stator;
a driving magnet having a center thereof disposed to coincide with that of the stator core in an axial direction; and
a rotor hub including a hub body having a disk shape, a magnet mounting part extended from an edge of the hub body in a downward axial direction and having the driving magnet installed on an inner peripheral surface thereof, and a disk supporting part extended from the magnet mounting part in a radial direction,
wherein the stator includes a base member, and
a pulling magnet is installed on at least one of a lower surface of the disk supporting part and an upper surface of the base member disposed to face the lower surface of the disk supporting part.

2. The spindle motor of claim 1, wherein the driving magnet and the pulling magnet are formed of different materials.

3. The spindle motor of claim 2, wherein the driving magnet and the pulling magnet are disposed to be spaced apart from each other by a predetermined distance in the radial direction.

4. The spindle motor of claim 2, wherein the pulling magnet is formed of a rubber magnet containing Sr-Ferrite or Ba-Ferrite and having a residual magnetic flux density of 2 to 4 KGauss, and
the driving magnet is formed of a rare-earth magnet having a residual magnetic flux density of 6 to 15 KGauss.

5. The spindle motor of claim 1, wherein the pulling magnet is inserted into an installation groove recessed from the lower surface of the disk supporting part, and
the stator further includes a pulling plate inserted into a mounting groove formed in the upper surface of the base member to generate pulling force in conjunction with the pulling magnet.

6. The spindle motor of claim 5, wherein the base member is formed of a diamagnetic or non-magnetic material.

7. The spindle motor of claim 1, wherein the pulling magnet is inserted into an installation groove recessed from the lower surface of the disk supporting part, and
the base member is formed of a ferromagnetic material so as to generate pulling force in conjunction with the pulling magnet.

8. The spindle motor of claim 1, wherein the pulling magnet is inserted into a mounting groove formed in the upper surface of the base member, and
the rotor hub is formed of a ferromagnetic material so as to generate pulling force in conjunction with the pulling magnet.

9. The spindle motor of claim 1, wherein the pulling magnet has a ring shape or a plurality of pulling magnets are disposed to be spaced apart from each other in a circumferential direction.

10. The spindle motor of claim 1, wherein the base member includes an installation part having the stator core installed on an outer peripheral surface thereof.

11. The spindle motor of claim 10, wherein the stator further includes a sleeve supporting a shaft rotating together with the rotor hub.

12. The spindle motor of claim 10, wherein the stator further includes a lower thrust member fixedly installed on the installation part and a shaft having a lower end portion fixed to the lower thrust member, and
the rotor hub is extended from a sleeve rotating around the shaft.

13. A recording disk driving device comprising:
the spindle motor of claim 1 rotating a recording disk;
a head transfer part transferring a head detecting information of the recording disk mounted on the spindle motor to the recording disk; and
a housing accommodating the spindle motor and the head transfer part therein.
